(19) United States
(12) Patent Application Publication
(10) Pub. No.: US 2025/0267103 A1
(43) Pub. Date: Aug. 21, 2025

(54) TECHNIQUES TO USE SERVICE-LEVEL AUTHENTICATION AND AUTHORIZATION FOR MULTIPLE APPLICATIONS

(71) Applicant: QUALCOMM Incorporated, San Diego, CA (US)

(72) Inventors: Sunghoon KIM, San Diego, CA (US); Stefano FACCIN, San Ysidro, CA (US)

(21) Appl. No.: 19/053,334

(22) Filed: Feb. 13, 2025

Related U.S. Application Data
(60) Provisional application No. 63/554,841, filed on Feb. 16, 2024.

(51) Int. Cl. H04L 47/24; H04W 28/02

(52) U.S. Cl. CPC H04L 47/24; H04W 28/02

(57) ABSTRACT

Methods, systems, and devices for method for wireless communication are described. A network entity may obtain a first request to validate a first service for a user equipment (UE), the first request including an indicator of the first service. The network entity may establish a protocol data unit session with a set of traffic filters in accordance with the first request. The network entity may then obtain a second request to validate a second service for the UE, the second request including an indicator of the second service. The network entity may modify the protocol data unit session based on the second request, where modifying the protocol data unit session includes modifying at least one traffic filter of the set of traffic filters.

### CROSS REFERENCES

The present application for patent claims benefit of U.S. Provisional Patent Application No. 63/554,841 by Kim et al., entitled “TECHNIQUES TO USE SERVICE-LEVEL AUTHENTICATION AND AUTHORIZATION FOR MULTIPLE APPLICATIONS,” filed Feb. 16, 2024, assigned to the assignee hereof, and expressly incorporated herein.

### FIELD OF TECHNOLOGY

The following relates to method for wireless communication, including techniques to use service-level authentication and authorization (AA) for multiple applications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques to use service-level AA for multiple applications. For example, the described techniques provide for a network entity (e.g., session management function (SMF)) to receive a first request from a UE to validate a first service associated with a first application function (AF). The network entity may establish a protocol data unit session with a set of pre-defined traffic filters associated with the first service. The network entity may further receive a second request to validate a second service associated with a second AF. The network entity may modify the existing protocol data unit session to update the set of traffic filters for the second service.

A method by a network entity is described. The method may include obtaining a first request to validate a first service for a user equipment (UE), the first request including an indicator of the first service, establishing a protocol data unit session with a set of traffic filters in accordance with the first request, obtaining a second request to validate a second service for the UE, the second request including an indicator of the second service, and modifying the protocol data unit session based on the second request, where modifying the protocol data unit session includes modifying at least one traffic filter of the set of traffic filters.

A network entity is described. The network entity may include one or more memories storing processor executable code, and one or more processors coupled with the one or more memories. The one or more processors may individually or collectively be operable to execute the code to cause the network entity to obtain a first request to validate a first service for a UE, the first request including an indicator of the first service, establish a protocol data unit session with a set of traffic filters in accordance with the first request, obtain a second request to validate a second service for the UE, the second request including an indicator of the second service, and modify the protocol data unit session based on the second request, where modifying the protocol data unit session includes modifying at least one traffic filter of the set of traffic filters.

Another network entity is described. The network entity may include means for obtaining a first request to validate a first service for a UE, the first request including an indicator of the first service, means for establishing a protocol data unit session with a set of traffic filters in accordance with the first request, means for obtaining a second request to validate a second service for the UE, the second request including an indicator of the second service, and means for modifying the protocol data unit session based on the second request, where modifying the protocol data unit session includes modifying at least one traffic filter of the set of traffic filters.

A non-transitory computer-readable medium storing code is described. The code may include instructions executable by one or more processors to obtain a first request to validate a first service for a UE, the first request including an indicator of the first service, establish a protocol data unit session with a set of traffic filters in accordance with the first request, obtain a second request to validate a second service for the UE, the second request including an indicator of the second service, and modify the protocol data unit session based on the second request, where modifying the protocol data unit session includes modifying at least one traffic filter of the set of traffic filters.

Some examples of the method, network entities, and non-transitory computer-readable medium described herein may further include operations, features, means, or instructions for initiating, based on obtaining the first request, a first service-level validation of the first service, where the first service may be validated by a first application function and initiating, based on obtaining the second request, a second service-level validation of the second service, where the second service may be validated by a second application function different from the first application function.

In some examples of the method, network entities, and non-transitory computer-readable medium described herein, the set of traffic filters enable a first flow of traffic associated with the first service based on the first service-level validation of the first service being successful and the set of traffic filters including the modified at least one traffic filter enable a second flow of traffic associated with the second service based on the second service-level validation of the second service being successful.

In some examples of the method, network entities, and non-transitory computer-readable medium described herein, the first application function and the second application function may be external to the network entity.

In some examples of the method, network entities, and non-transitory computer-readable medium described herein, the network entity communicates with the first application function and the second application function via a network exposure function.

Some examples of the method, network entities, and non-transitory computer-readable medium described herein may further include operations, features, means, or instructions for releasing the protocol data unit session based on determining that the first service-level validation of the first service and the second service-level validation of the second service may be not complete within a threshold time period.

Some examples of the method, network entities, and non-transitory computer-readable medium described herein may further include operations, features, means, or instructions for obtaining the set of traffic filters to identify a flow of traffic associated with the first service based on the first service-level validation of the first service being successful.

Some examples of the method, network entities, and non-transitory computer-readable medium described herein may further include operations, features, means, or instructions for outputting an indication of a capability to support a service-level validation of services supported by the UE, where obtaining the first request and the second request may be based on outputting the indication of the capability.

Some examples of the method, network entities, and non-transitory computer-readable medium described herein may further include operations, features, means, or instructions for obtaining an indication of revocation of validation of the first service and removing a traffic filter from the set of traffic filters in response to obtaining the indication, where the traffic filter corresponds to the first service.

Some examples of the method, network entities, and non-transitory computer-readable medium described herein may further include operations, features, means, or instructions for determining that the set of traffic filters may be exclusive of active traffic filters for the protocol data unit session and releasing the protocol data unit session in response to determining that the set of traffic filters may be exclusive of active traffic filters for the protocol data unit session.

Some examples of the method, network entities, and non-transitory computer-readable medium described herein may further include operations, features, means, or instructions for releasing the protocol data unit session upon expiration of a timer, where the timer may be initiated upon determining that set of traffic filters may be exclusive of active traffic filters for the protocol data unit session.

Some examples of the method, network entities, and non-transitory computer-readable medium described herein may further include operations, features, means, or instructions for establishing the protocol data unit session may be based on a subscription data, the indicator of the first service, or both and the subscription data indicates that the protocol data unit session may be associated with a service-level validation of the UE.

In some examples of the method, network entities, and non-transitory computer-readable medium described herein, the set of traffic filters enable flow of traffic not subject to service-level validation, traffic associated with a successful service-level validation, or both.

In some examples of the method, network entities, and non-transitory computer-readable medium described herein, the indicator of the first service includes a service level indicator.

In some examples of the method, network entities, and non-transitory computer-readable medium described herein, the network entity includes a session management function.

### BRIEF DESCRIPTION OF THE DRAWINGS

FIG. 1 shows an example of a wireless communications system that supports techniques to use service-level AA for multiple applications in accordance with one or more aspects of the present disclosure.

FIG. 2 shows an example of a wireless communications system that supports techniques to use service-level AA for multiple applications in accordance with one or more aspects of the present disclosure.

FIG. 3 shows an example of a process flow that supports techniques to use service-level AA for multiple applications in accordance with one or more aspects of the present disclosure.

FIGS. 4 and 5 show diagrams of devices that support techniques to use service-level AA for multiple applications in accordance with one or more aspects of the present disclosure.

FIG. 6 shows a diagram of a communications manager that supports techniques to use service-level AA for multiple applications in accordance with one or more aspects of the present disclosure.

FIG. 7 shows a diagram of a system including a device that supports techniques to use service-level AA for multiple applications in accordance with one or more aspects of the present disclosure.

FIGS. 8 through 10 show flowcharts illustrating methods that support techniques to use service-level AA for multiple applications in accordance with one or more aspects of the present disclosure.

### DETAILED DESCRIPTION

Some wireless communications systems may provide multiple services to a UE to support different functionality and applications at the UE. In some implementations, a network may be designed to facilitate these services. A UE in combination with the network may support authentication and authorization for various services. In some examples, the services may include services that are enabled via communication provided by the network. A UE may trigger a service-level AA procedure. Such authentication and authorization procedure may involve communications and coordination between different network entities (e.g., a SMF, a network exposure function (NEF), or a network application function (NAF)). However, techniques for facilitating authentication and authorization for different services may be undefined or underdeveloped.

The described techniques relate to supporting authentication and authorization for various services. In particular, the described techniques relate to supporting a mechanism for generic (e.g., non-service specific) authentication and authorization (AA) by a third party external application function (AF). The generic AA depicted herein enables application programming interface (API)-based and Hypertext Transfer Protocol (HTTP)-based authentication and may allow a network to authenticate or authorize a protocol data unit session for more than one application level identifier (ID) by more than one AF. Thus, the techniques depicted herein may enable a network entity to perform the generic AA for multiple service-level IDs corresponding to one or more AFs. The network entity (e.g., SMF) may establish a single protocol data unit session (e.g., between the UE and the UPF), which may be shared by multiple services, each subject to the generic AA.

A network entity (e.g., SMF) may receive a first request from a UE to validate a first service associated with a first AF. The UE may include a service-level ID in the first request. The network entity may establish a protocol data unit session with a set of pre-defined traffic filters, upon receiving the request. The network entity may then receive a second request to validate a second service associated with a second AF. Instead of establishing a new protocol data unit session, the network entity may modify the existing protocol data unit session to update the set of traffic filters based on the second request. In some examples, the first AF may provide an AA for the first service and the second AF may provide an AA for the second service. Upon a successful generic AA, each corresponding AF may provide new traffic policies to identify the traffic that is enabled for the protocol data unit session.

Aspects of the disclosure are initially described in the context of wireless communications systems. Aspects of the disclosure are further illustrated by and described with reference to process flows. Aspects of the disclosure are further illustrated by and described with reference to apparatus diagrams, system diagrams, and flowcharts that relate to techniques to use service-level AA for multiple applications.

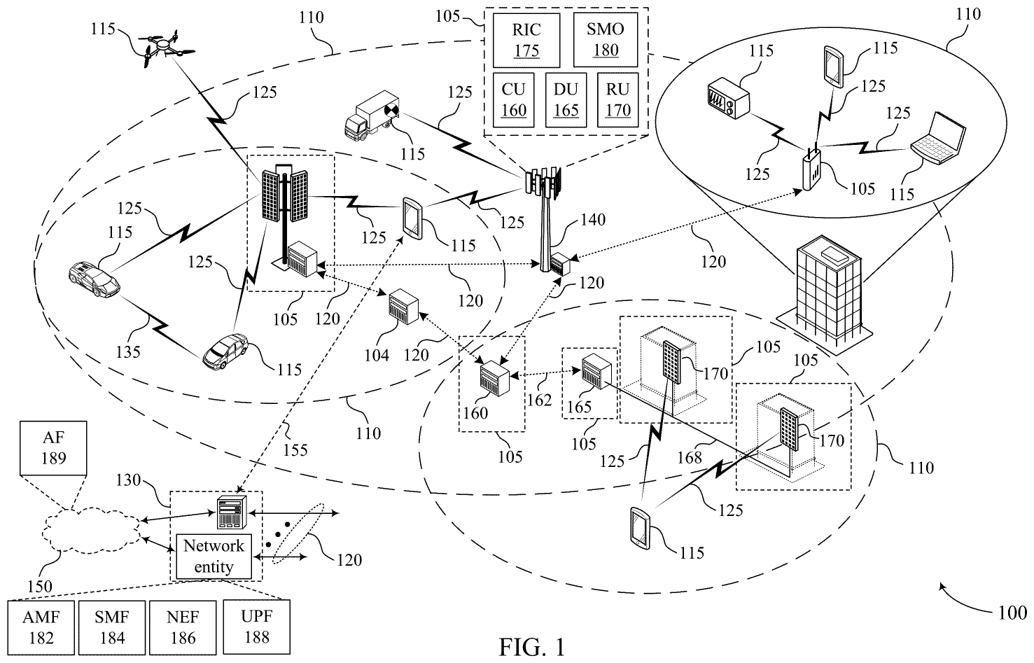

FIG. 1 shows an example of a wireless communications system 100 that supports techniques to use service-level AA for multiple applications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may include one or more network entities 105, such as an AMF 182, an SMF 184, an NEF 186, or a UPF 188. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service. The IP services 150 may include data networks, and may include or be coupled with one or more AFs 189.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Techniques described herein, in addition to or as an alternative to be carried out between UEs 115 and network entities 105, may be implemented via additional or alternative wireless devices, including IAB nodes 104, DUs 165, CUs 160, RUs 170, and the like. For example, in some implementations, aspects described herein may be implemented in the context of a disaggregated RAN architecture (e.g., open RAN (O-RAN) architecture). Some wireless communications systems (e.g., wireless communications system 100), infrastructure and spectral resources for NR access may additionally support wireless backhaul link capabilities in supplement to wireline backhaul connections, providing an IAB network architecture.

In some examples, the wireless communications system 100 may include a core network 130 (e.g., a next generation core network (NGC)), one or more IAB donors, IAB nodes 104, and UEs 115, where IAB nodes 104 may be partially controlled by each other and/or the IAB donor. The IAB donor and IAB nodes 104 may be examples of aspects of network entities 105. IAB donor and one or more IAB nodes 104 may be configured as (e.g., or in communication according to) some relay chain.

In the case of the techniques described herein applied in the context of a disaggregated RAN architecture, one or more components of the disaggregated RAN architecture (e.g., one or more IAB nodes 104 or components of IAB nodes 104) may be configured to support techniques for large round trip times in random access channel procedures as described herein. For example, some operations described as being performed by a UE 115 or a network entity 105 may additionally, or alternatively, be performed by components of the disaggregated RAN architecture (e.g., IAB nodes, DUs, CUs, etc.).

The wireless communications system 100 may support uplink or downlink communications with one or more cells or sidelink communications with each other. To facilitate the uplink, downlink, and sidelink communications by UEs 115 (e.g., aerial UEs, terrestrial UEs, or both), the wireless communications system 100 may define a spectrum dedicated to UEs 115. The dedicated spectrum may be for uplink and downlink communications between UEs 115 and one or more cells (e.g., over a Uu interface), or the dedicated spectrum may be for sidelink communications between UEs 115 (e.g., over a PC5 interface). In addition to the dedicated spectrum, UEs 115 may operate in other wireless spectrums. The wireless communications system 100 may support efficient techniques for operation of UEs 115 in dedicated spectrum and other spectrums. In some examples, a UE 115 may be a UAV or drone, or a UE 115 installed in a UAV or drone.

The wireless communications system 100 may support a generic AA procedure to authenticate and authorize a UE 115 for multiple services, in some examples. The AA procedure may be a part of a NAS procedure for multiple services (e.g., aerial services, autonomous navigation services, low-latency services, mission-critical services, IoT services). The NAS procedure may include operations by a UE 115 and a network. A UE 115 supporting UAS services may include a service-level device identifier (ID) in a request for AA, and the service-level device identifier may trigger a service-level AA procedure. The service-level device identifier may refer to a unique identifier of a service at a UE 115. An SMF may receive the request for AA from the UE 115, and the SMF may check a subscription of the UE 115 for UAS. The SMF may then trigger a UAV USS AA (UUAA) procedure or reject the request from the UE (e.g., with a cause of ‘UAS services not allowed’).

Various messages may be exchanged between a UE 115 and a network and between network entities 105 in the network to facilitate an AA procedure for services. Examples of these messages include a service-level AA container (SLAC) carrying the request for AA from the UE 115 to the SMF, an NEF authentication message from the SMF to an NEF, and a AF authentication message from the NEF to an AF. In some examples, in addition to aerial services, the wireless communications system 100 may provide other services to UEs 115 to support different functionality and applications at the UEs 115. Examples of services supported by the wireless communications system 100 may include gaming services, streaming services, extended reality services, virtual office services, aerial services, and others. In some examples, it may be appropriate for the wireless communications system 100 to support AA for various services provided by the wireless communications system 100. A UE 115 may transmit the SLAC as part of a session management (SM) NAS, service-level AA procedure or to initiate the SM NAS, service-level AA procedure. The SMF may transmit the NEF authentication message to the NEF along with other messages to facilitate AA (e.g., AA for aerial services), and the NEF may transmit the AF authentication message to the AF along with other messages to facilitate AA for aerial services.

An SLAC may include fields for a service-level-AA device identifier, a service-level-AA server address, a service-level-AA response, a service-level-AA payload type, a service-level-AA pending indication, and a service-level-AA payload. The service-level-AA device identifier field may include a service-level device identifier information element identifier, a service-level device identifier length, and the service-level-AA device identifier. The service-level-AA response field may include a service-level-AA response or a command and control (C2) AA response. A service-level-AA payload type field may include eight bits where a first value indicates a UUAA payload, a second value indicates a C2 authorization payload, and all other values are reserved. In some examples, payload type encoding in an SLAC for UUAA and C2 authorization may be specified.

Upon receiving an application layer request, the UE may include the SLAC in a protocol data unit session establishment message with a service-level device ID set to CAA-level UAV ID. Upon receiving the SLAC, the SMF may check UE subscription to determine whether it requires UUAA, and trigger UUAA procedure by invoking Nnef_auth services (including service-level device ID). The UAS network function (UAS-NF) (NEF) may trigger Naf_auth services by including the service-level device ID. The USS (AF) may trigger Naf_auth notification service to UAS-NF (NEF) including an authentication message. The UAS-NF (NEF) may then trigger Nnef_auth notification services to SMF with including the authentication message. An NEF authentication message may be modeled according to an Nnef_auth data model and may include UAV authentication information, an authentication notification, a UAV authentication response, a UAV authentication failure, an authentication result, and a notification type. The UAV authentication information may include a generic public subscription identifier (GPSI), a service-level device identifier, an internet protocol (IP) address of a UE 115, an authentication message, a permanent equipment identifier (PEI), an authentication server address, an authentication notification uniform resource identifier (URI), a data network name (DNN), single network slice selection assistance information (S-NSSAI), UE location information, and a network function type (e.g., AMF or SMF).

The SMF may further set the service-level AA payload of the SLAC to the received authentication msg message, and may include the SLAC in the Service-Level Authentication Command message. The UE 115 may forward the received service-level AA payload to an upper layer. The upper layer of the UE 115 may provide the UE 115 with a UUAA payload, and the UE 115 may then set the service-level AA payload of the SLAC to the received UUAA payload and include the SLAC in the Service-Level Authentication Complete message. The SMF may then forward the service-level AA payload to UAS-NF (NEF) by invoking Nnef_auth service (including authentication message). In particular, the UAS-NF (NEF) may trigger Naf_auth services by including the authentication message. In some examples, the USS (AF) may send an authentication result by invoking Naf_auth notification service. The UAS-NF (NEF) may use the authentication result to trigger Nnef_auth notification services for SMF. The SMF may send a protocol data unit session establishment accept message with including SLAC, where the service-level-AA result (SLAR field) is set to successful. Finally, the UE 115 may forward the result of service-level AA procedure and proceed with a NAS procedure.

As depicted herein, a UE supporting UAS services can include a service-level device ID which triggers a service-level AA procedure. In addition, the SMF may check UE session management subscription data for UAS, and may accept the request and trigger UUAA procedure, or reject the request from the UE with cause ‘UAS services not allowed’. The SLAC may support two types of payload-UUAA and command and control (C2) authorization. In some examples, the techniques depicted herein may provide for adapting an AA procedure to make the AA procedure generic (e.g., not limited to UAS features). A NAS procedure and container may be introduced to cope with a vertical service supporting AA. In addition, data model and descriptions may be updated to be more generic and not limited to UAS. Further, although an authentication message (e.g., ‘authmsg’) from an SMF may be used for any service, a data model and descriptions for an NEF authentication message may be UAS-specific. Similarly, although an authentication message (e.g., ‘authmsg’) from an NEF may be used for any service, a data model and descriptions for an AF authentication message may be UAS-specific.

If multiple services are available to UEs 115, techniques depicted herein provide for adapting an AA procedure (e.g., update one or more APIs for the AA procedure) to enable AA for multiple services (e.g., vertical services). For instance, it may be appropriate to allow for the selection of network functions (e.g., an NEF or AF) supporting a target function or service. In addition, the AA procedure may be adopted to generic AA by a third party external AF. Such generic AA for multiple services may extend the usage of service-level AA procedure to any services associated with a RAN assisted AA. The techniques depicted herein enables an API-based and HTTP-based authentication, thereby supporting security mechanisms that may be implemented by third party services and providers.

Aspects of the present disclosure provide for control plane (UE and network) enhancement for services associated with the AA procedure. In some examples, SM NAS procedure and information may be enhanced to support service-level AA procedure for general purpose. In some examples, a service-level identifier may be defined for all services supported by a UE 115, and a UE 115 may include a service-level device identifier in a request for AA. A subscription of a UE 115 (e.g., UE subscription) may allow a network to perform an AA procedure for the UE 115 for one or more services. An SMF may check a subscription of a UE 115 to determine if a vertical service for which AA is requested is allowed for the UE 115. In some cases, if a UE 115 is capable of supporting multiple services, there may be multiple services applicable for a single UE subscription (e.g., a first UE may have a subscription for service X, service Y, and service Z). In such cases, it may be appropriate for an SMF or NEF to identify a service for which a UE 115 is requesting AA.

The techniques of the present disclosure provide for determining the services requiring service-level AA procedure and identifying target AF or target services (both uplink and downlink). According to one or more aspects depicted herein, a network entity may receive a request to validate a service by a third party AF. In such cases, a UE subscription-based control may determine whether to perform service-level AA procedure for one or more services. In an example, if a UE 115 is requesting AA for a first service X and a second service Y, an SMF may establish a single protocol data unit session with a set of traffic filters in response to receiving the request from the UE 115. An SMF may identify a service for which a UE 115 is requesting AA, and the SMF may select a proper NEF which may connect the UE 115 to an AF supporting the service. The NEF may then select the AF (e.g., the target AF). The target AF may then provide service-level AA for the service indicated in the request.

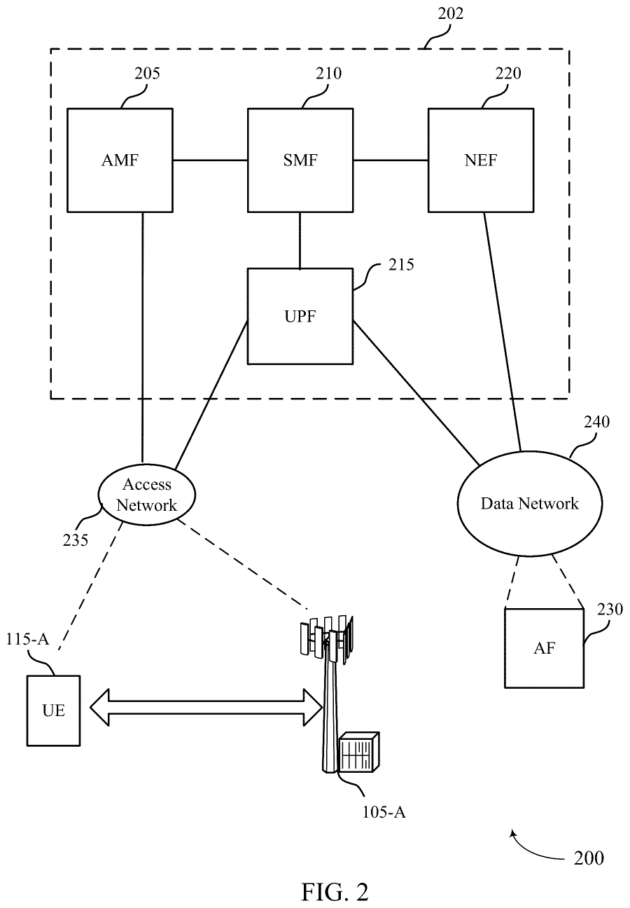

FIG. 2 shows an example of a wireless communications system 200 that supports techniques to use service-level AA for multiple applications in accordance with one or more aspects of the present disclosure. The wireless communications system 200 includes an access network 235, which may, for example, support communications between a UE 115-a and a network entity 105-a. The wireless communications system 200 also includes a core network 202, which may be an example of a 5G core network. The wireless communications system 200 may be an example of a wireless communications system 100 as described with reference to FIG. 1. The UE 115-a may be an example of a UE 115 as described with reference to FIG. 1. The access network 235 may include one or more network entities 105, which may be examples of CUs, DUs, RUs, or any combination thereof, as described with reference to FIG. 1. The core network 202 may include additional network entities 105 such as an AMF 205, an SMF 210, a UPF 215, an NEF 220, or any combination thereof. The UPF 215 may be connected to a data network 240, which may include or be coupled with an AF 230 (or multiple AFs). As depicted herein, the wireless communications system 200 may support efficient techniques to facilitate generic service-level AA for various services.

To support service-level AA (e.g., generic service-level AA) for multiple applications, the UE 115-a may transmit a message to the AMF 205 (e.g., via access network 235). The message may include, or be an example of, a protocol data unit session establishment message and may indicate that the UE 115-a is requesting validation of a first service for the UE 115-a. The UE 115-a may support a first service and a second service. In some examples, the UE 115-a may output a container to the network entity 105-a to request AA for the first service for the UE 115-a. The container may include an indicator of the first service that distinguishes or identifies the first service from multiple services. Generic service-level AA allows the UE 115-a to authenticate or authorize a protocol data unit session for an application level ID by one AF. In some examples, a protocol data unit session is either accepted or rejected based on service-level AA success or failure. For example, an AF 230 may perform an AA based on the application level ID (e.g., service-level ID) included in a request from the UE 115-a. If the service-level AA is a failure, then the SMF 210 in conjunction with the NEF 220 may release the protocol data unit session.

The UE 115-a and the network entity 105-a may implement the techniques depicted herein to perform a generic service-level AA for multiple identifiers (e.g., service-level IDs) corresponding to one or more AFs, and have traffic enabled for each service-level IDs separately. A protocol data unit session established by the SMF 210 and the NEF 220 may be shared by multiple services, where each service is subject to service-level AA.

As depicted in the example of FIG. 2, the SMF 210 may establish a protocol data unit session configured for service-level AA (in unified data management (UDM) included in subscription information) for authorized UEs 115. For instance, a UDM may provide SM subscription data to the UE 115. Such subscription data may indicate that a protocol data unit session associated with the SM is subject to service-level AA of the UE. The SMF 210 may use a data network name (DNN) for the protocol data unit session in a UE subscription profile, to establish the protocol data unit session. In some examples, the UDM subscription for the UE 115-a may include a list of authorized DNNs. For DNNs subject to service-level AA, the DNNs may include an indication of service-level AA (e.g., a GSLAA Required Indication) with associated traffic filter information. The indication of service-level AA may specify that the subscription information indicates that no protocol data unit session for the DNN subject to service-level AA can be established unless the UE 115-a provides a service level ID. Additionally, the indication of service-level AA indicates that the SMF 210 is to trigger a service-level AA at the protocol data unit session establishment. Otherwise, in such cases, the protocol data unit session establishment request is rejected.

In some examples, the subscription information may also include whether multiple services (e.g., services needing service-level AA) are allowed for the DNN (Multiple GSLAA Indication). Upon receiving such an indication, the SMF 210 may establish and release the protocol data unit session accordingly (e.g., the SMF 210 may analyze each of the service-level IDs prior to releasing the protocol data unit session). In some examples, the NEF 220 may manage a list of SLIDs and a corresponding status of service-level AA for each SLID.

Upon receiving, from the UE 115-a, a first request to validate a first service and a second request to validate a second service, the SMF 210 may establish a protocol data unit session marked as being subject to service-level AA. The SMF 210 may establish a common protocol data unit session for both requests. Additionally, or alternatively, the SMF 210 may establish the protocol data unit session with pre-defined traffic filters that enable traffic not subjected to service-level AA (e.g., for services that are not subject to third party AF 230 AA). In some examples, the pre-defined traffic filters may state that no traffic is allowed until a successful service-level AA takes place. In some examples, the pre-defined traffic filter can enable the UE 115-a to send initial app-layer signaling (e.g., HTTP request) to the AF 230, and it may trigger the service-level AA. If no traffic is allowed and the UE 115-a does not perform a service-level AA (e.g., generic service-level AA) within a configured time, then the SMF 210 may release the protocol data unit session.

Upon receiving the request for validation from the UE 115-a, the AMF 205 may use the UDM subscription information to identify that a DNN associated with the request requires a service-level AA for establishing a connection. In such cases, the AMF 205 may select an SMF capable of supporting service-level AA (e.g., generic service-level AA). As depicted herein, the UE 115-a may be configured with a service level ID for each service that is subject to service-level AA, and a list of DNNs for which service-level AA is to be performed using such service-level ID (e.g., configured in the application client and requested to the data link layer via a hardware component of the UE 115-a (e.g., a modem)).

For a protocol data unit session associated with service-level AA, the UE 115-a may include the DNN name in the protocol data unit session establishment request. If a protocol data unit session is already available, the UE 115-a may transmit a protocol data unit session modification request including a service-level ID (according to an application client request) and an AF address associated with the services subject to validation.

The AF 230 corresponding to each service may perform a service-level AA for each service requesting validation. Upon a successful service-level AA, the AF 230 may provide new traffic policies (e.g., via a policy and charging control (PCC)) to identify the traffic that is enabled on the protocol data unit session. The traffic policy may allow any traffic for the protocol data unit session. In some examples, the UE 115-a may receive the indication of the successful service-level AA. Upon receiving the indication of the successful service-level AA, the UE 115-a may provide the result to an application client which corresponds to the service-level ID for the successful service-level AA procedure. For example, the UE 115-a may identify which application's request has been successful by checking the service-level ID, and may indicate the results to the corresponding application client. In some examples, the service-level ID or an application ID may be provided to the PCC to enable application-specific charging.

When selecting an SMF 210 for establishing the protocol data unit session, the AMF 205 may consider subscription information from the UDM including a service-level AA indication for each DNN (whether each DNN is subject to service-level AA), a service-level AA indication for each S-NSSAI, and a service-level AA indication for each subscribed DNN. Additionally, the AMF 205 may consider whether selecting the same SMF for all protocol data unit sessions to the same S-NSSAI and DNN supporting service-level AA is requested. In some examples, an SMF that identifies a request to support service-level AA, and which does not support service-level AA, may trigger relocation of an incoming validation request (e.g., request for service-level AA) to another SMF. In some examples, selecting the SMF 210 for establishing a protocol data unit session for service-level AA for multiple services may be based on a capability of an SMF to support service-level AA.

In some examples, an AF 230 may trigger a revocation of a service-level AA for a service. In such cases, the NEF 220 may remove the traffic filters related to the specific service ID (e.g., associated with the service being revoked). For example, the NEF 220 may remove the traffic filter from an allowed traffic filter list. In some examples, if an established protocol data unit session or DNN is marked as being subject to service-level AA (e.g., GSLAA Required Indication is included in the DNN), the NEF 220 may decide to release the protocol data unit session when the last service-level ID is revoked.

In some examples, the NEF 220 may decide to release the protocol data unit session if the NEF 220 determines that no more service-level IDs are included in the protocol data unit session. In such cases, the NEF 220 may indicate to the SMF 210 to release the protocol data unit session. Additionally, or alternatively, if an established protocol data unit session or DNN is marked as being subject to service-level AA (e.g., GSLAA Required Indication is included in the DNN), and no traffic filters are active for the protocol data unit session (e.g., no traffic is allowed), then the SMF 210 may start a timer. After a preconfigured time from starting the timer, the SMF 210 may release the protocol data unit session. In such cases, the SMF 210 may indicate to the UE 115-a that no traffic is allowed. The SMF 210 may also be able to handle the case where the AF 230 fails to provide a traffic filter or when the PCC rule is not updated to allow traffic filters within the configured time. In some examples, the NEF 220 may manage a context for the traffic filter (e.g., NEF 220 stores the traffic filter for management purpose), and if no traffic filter is available, the NEF 220 may indicate to release the protocol data unit session to the SMF 210. In some examples, the SMF 210 may release the IP address or prefix(es) that were allocated to the protocol data unit session and may release the corresponding user plane resources. The SMF 210 may communicate one or more messages to the UPF or UE 115-a to release the protocol data unit session.

In some examples, if an established protocol data unit session or DNN is marked as being subject to service-level AA (e.g., GSLAA Required Indication is included in the DNN), and no traffic filters are active for the protocol data unit session (e.g., no traffic is allowed), the SMF 210 may start a timer when the last service-level ID is revoked. A preconfigured time after initiating the timer, the SMF 210 may release the protocol data unit session. The SMF 210 may indicate “no active service-level AA” as a reason for releasing the protocol data unit session. After release of the protocol data unit session, the UE 115-a may choose to re-initiate the protocol data unit session establishment procedure with requesting service-level AA.

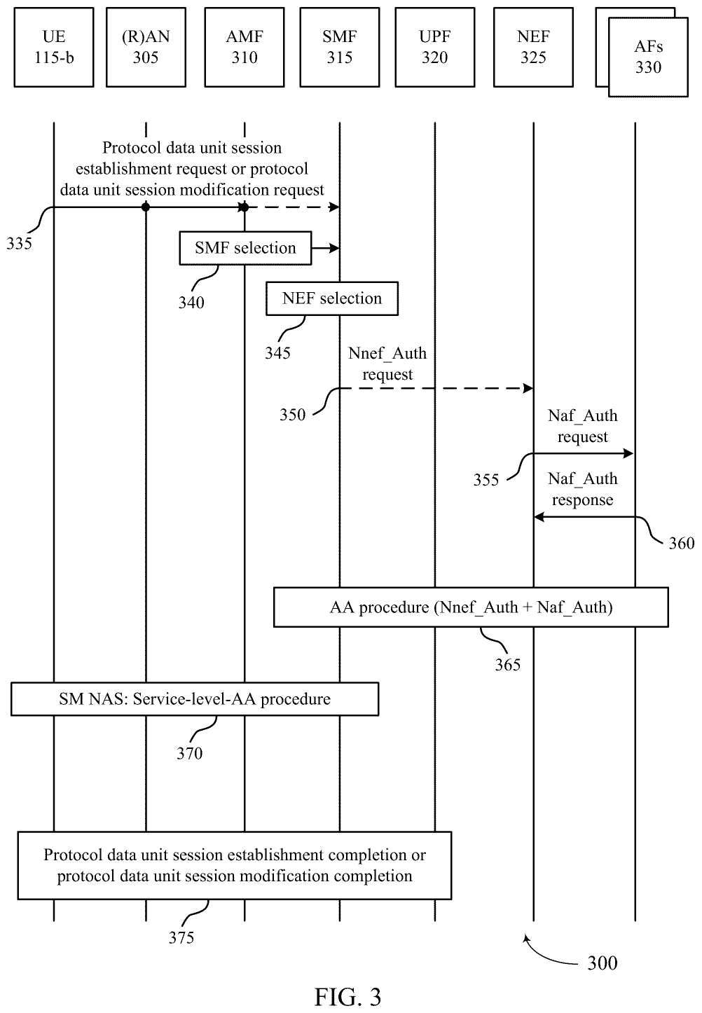

FIG. 3 shows an example of a process flow 300 that supports techniques to use service-level AA for multiple applications in accordance with one or more aspects of the present disclosure. The process flow 300 includes a UE 115-b, a RAN 305, an AMF 310, an SMF 315, a UPF 320, an NEF 325, and AFs 330, which may be examples of the corresponding devices in accordance with aspects of the present disclosure. The SMF 315 may be an example of a network entity 105, as described with reference to FIGS. 1 and 2. The process flow 300 may implement aspects of the wireless communications system 100 or the wireless communications system 200. For instance, the process flow 300 may support efficient techniques to facilitate AA for various services.

In the following description of the process flow 300, the signaling exchanged between the UE 115-b, the RAN 305, the AMF 310, the SMF 315, the UPF 320, the NEF 325, and the AFs 330 may be exchanged in a different order than the example order shown, or the operations performed by the UE 115-b, the RAN 305, the AMF 310, the SMF 315, the UPF 320, the NEF 325, and the AFs 330 may be performed in different orders or at different times. Some operations may also be omitted from the process flow 300, and other operations may be added to the process flow 300.

At 335, the UE 115-a may output, to the AMF 310 or the SMF 315, an SM NAS protocol data unit establishment request or protocol data unit session modification request. The SM NAS protocol data unit establishment request or protocol data unit session modification request may include a container that requests AA for a first service for the UE 115-b. The container may include a payload for an AA procedure. The container may include an indicator of the first service of a set of multiple services. The SMF 315 may obtain the container requesting AA for the first service from the UE 115-b. In some examples, the UE 115-a may output, to the AMF 310 or the SMF 315, a second request to verify a second service.

The service-level AA may optionally be triggered by the SMF 315 during a protocol data unit establishment and may be performed transparently via the NEF 325 with the authorizing/authenticating AF 330. The procedures may apply to the scenario where protocol data unit session(s) or protocol data network connection(s) for third party services may be established after a UE 115-b has been authenticated and authorized by the third party AF 330. When the UE 115-b requests establishment of a protocol data unit session or a protocol data network connection, the protocol data unit session or a protocol data network connection may be subject to service-level AA of the UE 115-b.

During the establishment or modification procedure of the protocol data unit session or a protocol data network connection, the AF 330 may provide the 3GPP system (e.g., RAN 305) with traffic filters that are enabled for the protocol data unit session after successful service-level AA.

The protocol data unit establishment request from the UE 115-b may include an indicator of the first service requesting validation. Additionally, or alternatively, the protocol data unit establishment request from the UE 115-b may include an indicator of the second service requesting validation. As depicted herein, the SMF 315 may trigger the service-level AA procedure during the protocol data unit establishment based on the SM subscription data obtained from the UDM (not shown), and a service level user identity (e.g., identifier) provided by the UE 115-b in the protocol data unit establishment request, at 335. In the SM subscription data, it may be indicated that the protocol data unit session or the protocol data network connection is subject to a service-level AA of the UE 115-b.

In some cases, the protocol data unit establishment request or protocol data unit session modification request may be directly routed to the SMF 315. However, in some other cases, the AMF 310 may perform an SMF selection, at 340. The UE 115-b may include a service level user identity, an authentication server address (e.g., the AF address), and a service-level AA payload provided by the application layer, in the protocol data unit establishment request or protocol data unit session modification request establishment request. Upon receiving the request, the AMF 310 may select the SMF 315 supporting the service-level AA procedure if the subscription information indicates that the DNN corresponding to the incoming request is subject to the service-level AA. In some cases, one or more service level user identities may be available in the UE 115-b for a DNN/S-NSSAI combination, which may be corresponding to one or more AFs 330. The UE 115-b may utilize an application layer configuration to select a service level user identity for the request for protocol data unit session connectivity.

The SMF 315 may determine to invoke an NEF service operation for service-level AA of the protocol data unit session establishment request based on the provided DNN/S-NSSAI combination, the service level user identity included in the protocol data unit session establishment request and determining that the SM subscription information requests service-level AA. If the SM subscription information indicates that it is subject to service-level AA, and the pre-defined traffic filters enable traffic not subject to service-level AA (e.g., for services allowed without service-level AA), the SMF 315 can proceed to step 375. If the SM subscription information requests service-level AA but service level user identity is not provided by the UE 115-b, then the SMF 315 may reject the establishment of the PDU Session.

To invoke an NEF service operation, at 345, the SMF 315 may perform NEF selection and may select the NEF 325 based on the NEF 325 supporting AA for the first service. For instance, the SMF 315 may identify the NEF 325 based on local configuration or by NEF discovery procedure using DNN/S-NSSAI and/or the authentication server address provided by the UE 115-b or stored in the subscription information (e.g., AF address).

At 350, the SMF 315 may output or obtain one or more messages with the NEF 325 to authenticate and authorize the UE 115-b for the first service based on the indicator of the first service. For instance, the SMF 315 may output an Nnef_Auth request to the NEF 325 to authenticate and authorize the UE 115-b for the first service based on the indicator of the first service. Additionally, the SMF 315 may output or obtain one or more messages with the NEF 325 to authenticate and authorize the UE 115-b for the second service based on the indicator of the second service.

The SMF 315 may invoke Nnef_Authentication_AuthenticateAuthorize service operation, including the service level user identity, a DNN, S-NSSAI, the authentication server address (e.g., the AF address), the service-level AA payload if it was provided by the UE, a GPSI, and the UE IP Address, if available. The NEF 325 may select an AF 330 based on either the service level user identity or the authentication server address (e.g., AF address) being received. In some examples, the SMF 315 may also provide a Notification Endpoint to the NEF 325, so that the SMF 315 is implicitly subscribed to be notified of re-authentication, update authorization data or revocation of service-level AA from the NEF 325, if the service-level AA result is successful.

At 350, the NEF 325 may obtain, from the SMF 315, a request to authenticate and authorize the UE 115-b for the first service or the second service or both. Such request may include an indicator of the first service of a set of multiple services or an indicator of the second service of the set of multiple services or both. The indicator in the request may be a service identifier, a service name, a server address, or a combination thereof.

At 355, the NEF 325 may perform AF selection and may select the AF 330 based on the AF 330 supporting AA for the first service. Additionally, or alternatively, the NEF 325 may select a second AF 330 based on the second AF 330 supporting AA for the second service. At 360, the NEF 325 may obtain an authentication response from the AF 330. In some examples, multiple round-trip messages may be implemented by the authentication method used by the AF 330. This step may be performed if the Naf_Authentication_AuthenticateAuthorize response message from the AF 330 in step 360 does not include a service-level AA result (indicating success or failure). In some examples, the Naf_Authentication_AuthenticateAuthorize response message (in 360) from the AF 330 may include GPSI and may include an authentication message based on an authentication method used that is forwarded transparently to UE 115-b over NAS mobility management (MM) transport messages.

At 365, the SMF 315, the NEF 325, and the AF 330 may exchange signaling (e.g., output or obtain one or more messages) as part of an AA procedure (e.g., Nnef_Auth and Naf_Auth) to authenticate and authorize the UE 115-b for the first service or the second service or both. In some examples, the AF 330 may send Naf_Authentication_AuthenticateAuthorize response to the NEF 325 with the AA result containing the service-level AA result (indicating success or failure) and the requested policy information (e.g., within the service-level AA authorization payload). The requested policy information from AF 330 may include a data network (DN) authorization profile index and/or a DN authorized session aggregate maximum bit rate (AMBR), or traffic filter(s) that is enabled on the protocol data unit session or that enables any traffic for the protocol data unit session. In some examples, the NEF 325 may confirm the successful service-level AA of the protocol data unit session. The NEF 325 may store the service-level AA result together with the service level user identity and an external identifier. The NEF 325 may also forward the service-level AA result, a service level user identity and the service-level AA payload, if received from the AF 330, to the SMF 315.

At 370, the UE 115-b, the AMF 310, and the SMF 315 may exchange signaling (e.g., output or obtain one or more messages) as part of an SM NAS service-level AA procedure to authenticate and authorize the UE 115-b for the first service or the second service or both. The SM NAS service-level AA procedure may be invoked if a Naf_Authentication_AuthenticateAuthorize response message in 360 does not indicate an authorization result.

At 375, the UE 115-b, the AMF 310, the SMF 315, and the UPF 320 may exchange signaling (e.g., output or obtain one or more messages) for protocol data unit session establishment completion or protocol data unit session modification completion. For example, the SMF 315 may establish a protocol data unit session with the set of traffic filters in accordance with the first request (for the first service). Upon receiving the second request, the SMF 315 may modify the protocol data unit session based on the second request (instead of establishing a new session), where modifying the protocol data unit session may include modifying at least one traffic filter of the set of traffic filters. If both services are authenticated by their respective AFs, then the UE 115-b, the AMF 310, and the SMF 315 may exchange signaling (e.g., output or obtain one or more messages) for protocol data unit session establishment completion or protocol data unit session modification completion for both services. If one of the services is not authenticated (service-level AA is unsuccessful or timed out), then the UE 115-b, the AMF 310, and the SMF 315 may exchange signaling (e.g., output or obtain one or more messages) for protocol data unit session establishment completion or protocol data unit session modification completion for the remaining service (the identifier of the unsuccessful service is removed from the protocol data unit session establishment). In some examples, if the SMF 315 receives traffic filter(s) from the AF 330, then the SMF 315 may send traffic filter(s) to a policy control function (PCF) to inform the UPF 320 of the allowed traffic for the protocol data unit session by the AF 330. The UPF 320 may implement one or more updated filters for the protocol data unit session in accordance with the traffic filters received from the AF 330.

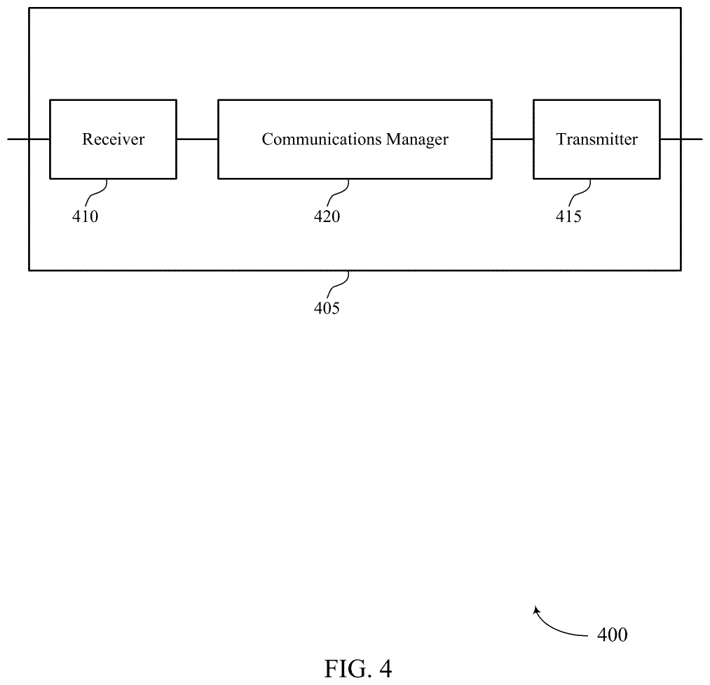

FIG. 4 shows a diagram 400 of a device 405 that supports techniques to use service-level AA for multiple applications in accordance with one or more aspects of the present disclosure. The device 405 may be an example of aspects of a network entity 105 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations or components thereof may be examples of means for performing various aspects of techniques to use service-level AA for multiple applications as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

For example, the communications manager 420 is capable of, configured to, or operable to support a means for obtaining a first request to validate a first service for a UE, the first request including an indicator of the first service. The communications manager 420 is capable of, configured to, or operable to support a means for establishing a protocol data unit session with a set of traffic filters in accordance with the first request. The communications manager 420 is capable of, configured to, or operable to support a means for obtaining a second request to validate a second service for the UE, the second request including an indicator of the second service. The communications manager 420 is capable of, configured to, or operable to support a means for modifying the protocol data unit session based on the second request, where modifying the protocol data unit session includes modifying at least one traffic filter of the set of traffic filters.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of communication resources.

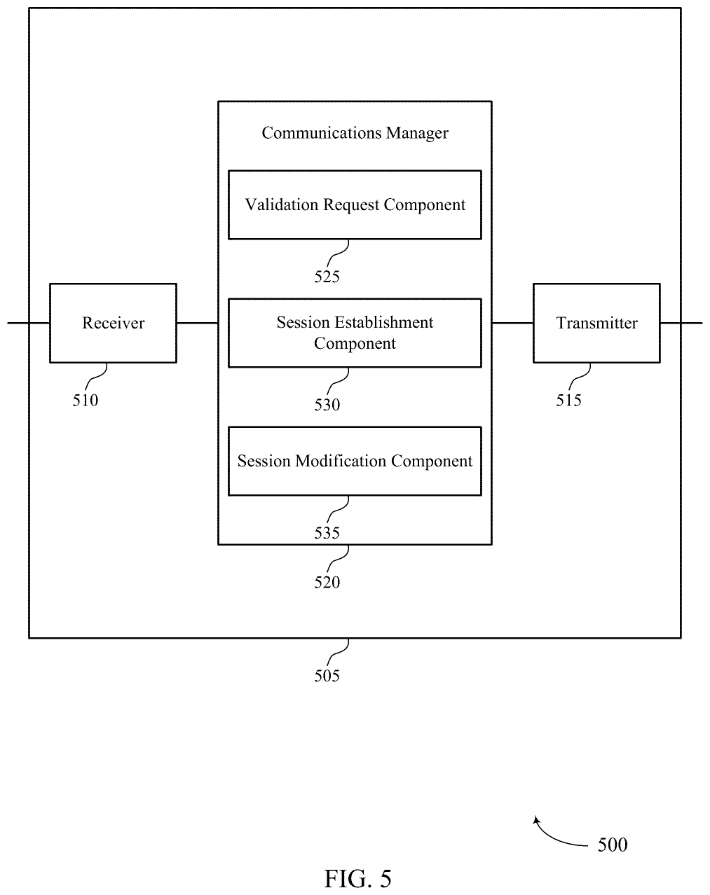

FIG. 5 shows a diagram 500 of a device 505 that supports techniques to use service-level AA for multiple applications in accordance with one or more aspects of the present disclosure. The device 505 may be an example of aspects of a device 405 or a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of techniques to use service-level AA for multiple applications as described herein. For example, the communications manager 520 may include a validation request component 525, a session establishment component 530, a session modification component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The validation request component 525 is capable of, configured to, or operable to support a means for obtaining a first request to validate a first service for a UE, the first request including an indicator of the first service. The session establishment component 530 is capable of, configured to, or operable to support a means for establishing a protocol data unit session with a set of traffic filters in accordance with the first request. The validation request component 525 is capable of, configured to, or operable to support a means for obtaining a second request to validate a second service for the UE, the second request including an indicator of the second service. The session modification component 535 is capable of, configured to, or operable to support a means for modifying the protocol data unit session based on the second request, where modifying the protocol data unit session includes modifying at least one traffic filter of the set of traffic filters.

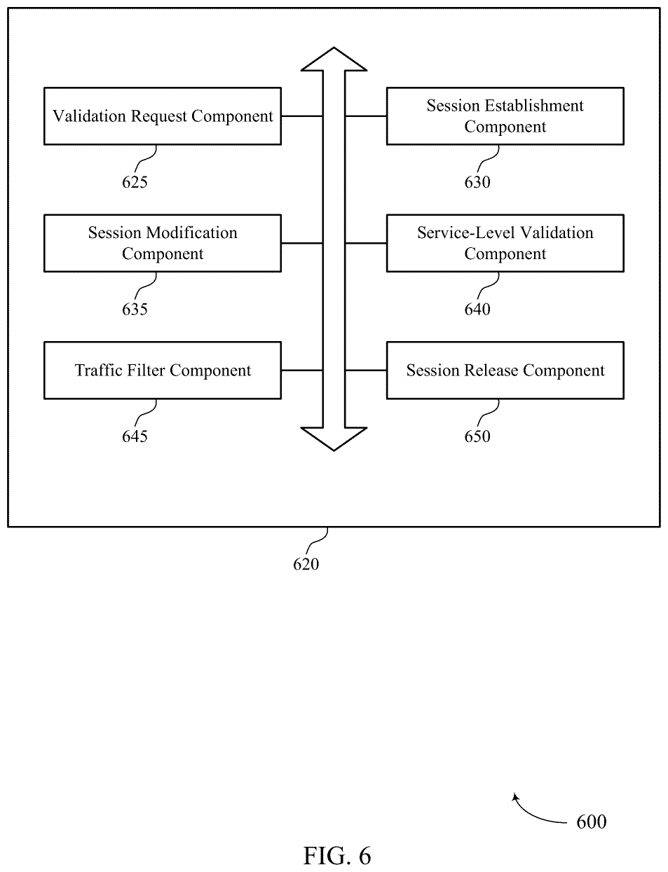

FIG. 6 shows a diagram 600 of a communications manager 620 that supports techniques to use service-level AA for multiple applications in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques to use service-level AA for multiple applications as described herein. For example, the communications manager 620 may include a validation request component 625, a session establishment component 630, a session modification component 635, a service-level validation component 640, a traffic filter component 645, a session release component 650, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The validation request component 625 is capable of, configured to, or operable to support a means for obtaining a first request to validate a first service for a UE, the first request including an indicator of the first service. The session establishment component 630 is capable of, configured to, or operable to support a means for establishing a protocol data unit session with a set of traffic filters in accordance with the first request. In some examples, the validation request component 625 is capable of, configured to, or operable to support a means for obtaining a second request to validate a second service for the UE, the second request including an indicator of the second service. The session modification component 635 is capable of, configured to, or operable to support a means for modifying the protocol data unit session based on the second request, where modifying the protocol data unit session includes modifying at least one traffic filter of the set of traffic filters.

In some examples, the service-level validation component 640 is capable of, configured to, or operable to support a means for initiating, based on obtaining the first request, a first service-level validation of the first service, where the first service is validated by a first AF. In some examples, the service-level validation component 640 is capable of, configured to, or operable to support a means for initiating, based on obtaining the second request, a second service-level validation of the second service, where the second service is validated by a second AF different from the first AF.

In some examples, the set of traffic filters enable a first flow of traffic associated with the first service based on the first service-level validation of the first service being successful and the set of traffic filters including the modified at least one traffic filter enable a second flow of traffic associated with the second service based on the second service-level validation of the second service being successful.

In some examples, the first AF and the second AF are external to the network entity. In some examples, the network entity communicates with the first AF and the second AF via a network exposure function.

In some examples, the session release component 650 is capable of, configured to, or operable to support a means for releasing the protocol data unit session based on determining that the first service-level validation of the first service and the second service-level validation of the second service are not complete within a threshold time period.

In some examples, the traffic filter component 645 is capable of, configured to, or operable to support a means for obtaining the set of traffic filters to identify a flow of traffic associated with the first service based on the first service-level validation of the first service being successful.

In some examples, the service-level validation component 640 is capable of, configured to, or operable to support a means for outputting an indication of a capability to support a service-level validation of services supported by the UE, where obtaining the first request and the second request is based on outputting the indication of the capability.

In some examples, the service-level validation component 640 is capable of, configured to, or operable to support a means for obtaining an indication of revocation of validation of the first service. In some examples, the traffic filter component 645 is capable of, configured to, or operable to support a means for removing a traffic filter from the set of traffic filters in response to obtaining the indication, where the traffic filter corresponds to the first service.

In some examples, the traffic filter component 645 is capable of, configured to, or operable to support a means for determining that the set of traffic filters is exclusive of active traffic filters for the protocol data unit session. In some examples, the session release component 650 is capable of, configured to, or operable to support a means for releasing the protocol data unit session in response to determining that the set of traffic filters is exclusive of active traffic filters for the protocol data unit session.

In some examples, the session release component 650 is capable of, configured to, or operable to support a means for releasing the protocol data unit session upon expiration of a timer, where the timer is initiated upon determining that set of traffic filters is exclusive of active traffic filters for the protocol data unit session.

In some examples, establishing the protocol data unit session is based on a subscription data, the indicator of the first service, or both. In some examples, the subscription data indicates that the protocol data unit session is associated with a service-level validation of the UE.

In some examples, the set of traffic filters enable flow of traffic not subject to service-level validation, traffic associated with a successful service-level validation, or both. In some examples, the indicator of the first service includes a service level indicator. In some examples, the network entity includes a session management function.

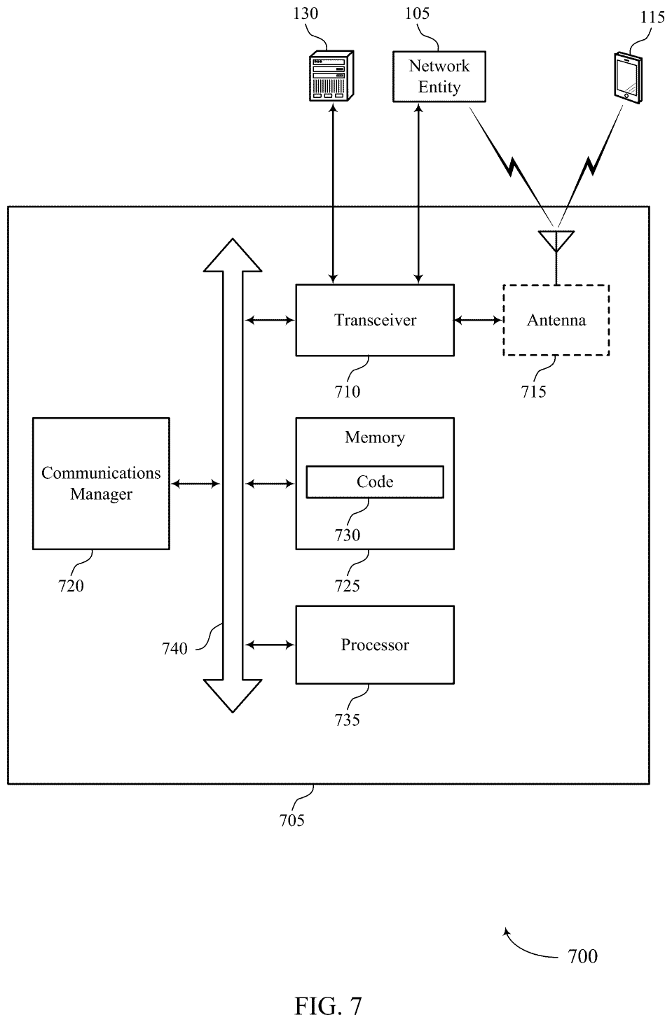

FIG. 7 shows a diagram of a system 700 including a device 705 that supports techniques to use service-level AA for multiple applications in accordance with one or more aspects of the present disclosure. The device 705 may be an example of or include components of a device 405, a device 505, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting techniques to use service-level AA for multiple applications). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725). In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network devices 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

For example, the communications manager 720 is capable of, configured to, or operable to support a means for obtaining a first request to validate a first service for a UE, the first request including an indicator of the first service. The communications manager 720 is capable of, configured to, or operable to support a means for establishing a protocol data unit session with a set of traffic filters in accordance with the first request. The communications manager 720 is capable of, configured to, or operable to support a means for obtaining a second request to validate a second service for the UE, the second request including an indicator of the second service. The communications manager 720 is capable of, configured to, or operable to support a means for modifying the protocol data unit session based on the second request, where modifying the protocol data unit session includes modifying at least one traffic filter of the set of traffic filters.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, and improved utilization of processing capability.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of techniques to use service-level AA for multiple applications as described herein, or the at least one processor 735 and the at least one memory 725 may be otherwise configured to, individually or collectively, perform or support such operations.

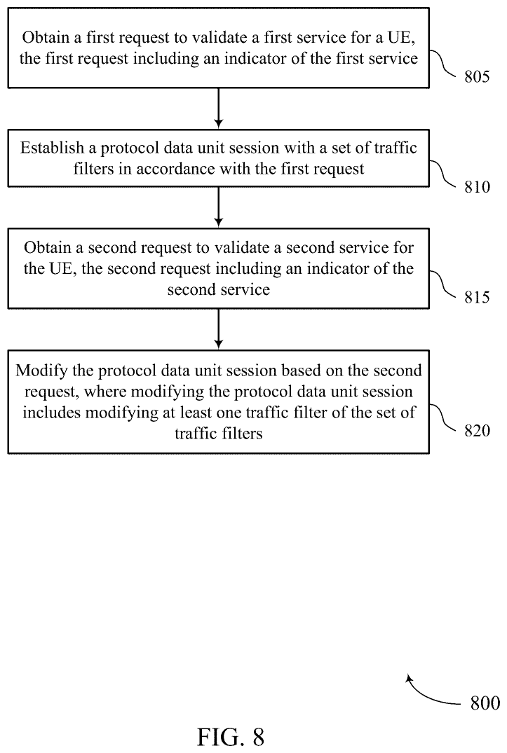

FIG. 8 shows a flowchart illustrating a method 800 that supports techniques to use service-level AA for multiple applications in accordance with one or more aspects of the present disclosure. The operations of the method 800 may be implemented by a network entity or its components as described herein. For example, the operations of the method 800 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 805, the method may include obtaining a first request to validate a first service for a UE, the first request including an indicator of the first service. The operations of 805 may be performed in accordance with examples as disclosed herein. In some examples, aspects of the operations of 805 may be performed by a validation request component 625 as described with reference to FIG. 6.

At 810, the method may include establishing a protocol data unit session with a set of traffic filters in accordance with the first request. The operations of 810 may be performed in accordance with examples as disclosed herein. In some examples, aspects of the operations of 810 may be performed by a session establishment component 630 as described with reference to FIG. 6.

At 815, the method may include obtaining a second request to validate a second service for the UE, the second request including an indicator of the second service. The operations of 815 may be performed in accordance with examples as disclosed herein. In some examples, aspects of the operations of 815 may be performed by a validation request component 625 as described with reference to FIG. 6.

At 820, the method may include modifying the protocol data unit session based on the second request, where modifying the protocol data unit session includes modifying at least one traffic filter of the set of traffic filters. The operations of 820 may be performed in accordance with examples as disclosed herein. In some examples, aspects of the operations of 820 may be performed by a session modification component 635 as described with reference to FIG. 6.

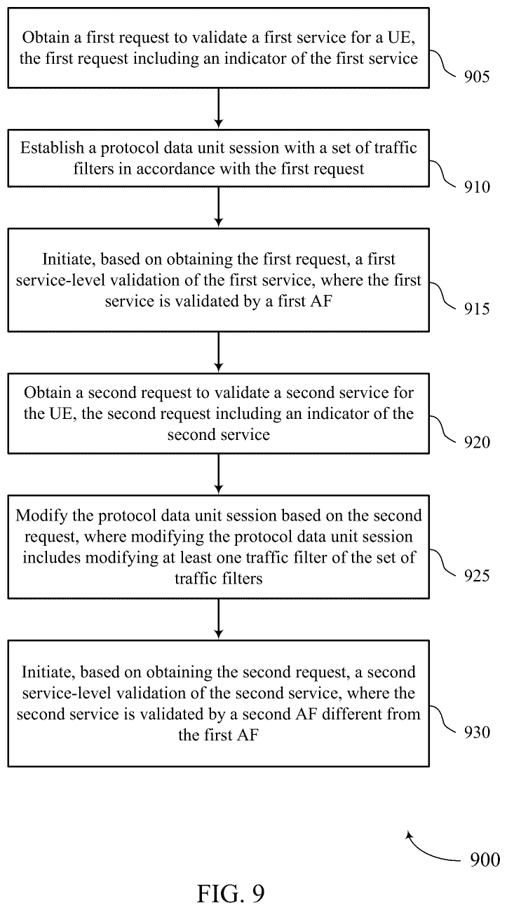

FIG. 9 shows a flowchart illustrating a method 900 that supports techniques to use service-level AA for multiple applications in accordance with one or more aspects of the present disclosure. The operations of the method 900 may be implemented by a network entity or its components as described herein. For example, the operations of the method 900 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 905, the method may include obtaining a first request to validate a first service for a UE, the first request including an indicator of the first service. The operations of 905 may be performed in accordance with examples as disclosed herein. In some examples, aspects of the operations of 905 may be performed by a validation request component 625 as described with reference to FIG. 6.

At 910, the method may include establishing a protocol data unit session with a set of traffic filters in accordance with the first request. The operations of 910 may be performed in accordance with examples as disclosed herein. In some examples, aspects of the operations of 910 may be performed by a session establishment component 630 as described with reference to FIG. 6.

At 915, the method may include initiating, based on obtaining the first request, a first service-level validation of the first service, where the first service is validated by a first AF. The operations of 915 may be performed in accordance with examples as disclosed herein. In some examples, aspects of the operations of 915 may be performed by a service-level validation component 640 as described with reference to FIG. 6.

At 920, the method may include obtaining a second request to validate a second service for the UE, the second request including an indicator of the second service. The operations of 920 may be performed in accordance with examples as disclosed herein. In some examples, aspects of the operations of 920 may be performed by a validation request component 625 as described with reference to FIG. 6.

At 925, the method may include modifying the protocol data unit session based on the second request, where modifying the protocol data unit session includes modifying at least one traffic filter of the set of traffic filters. The operations of 925 may be performed in accordance with examples as disclosed herein. In some examples, aspects of the operations of 925 may be performed by a session modification component 635 as described with reference to FIG. 6.

At 930, the method may include initiating, based on obtaining the second request, a second service-level validation of the second service, where the second service is validated by a second AF different from the first AF. The operations of 930 may be performed in accordance with examples as disclosed herein. In some examples, aspects of the operations of 930 may be performed by a service-level validation component 640 as described with reference to FIG. 6.

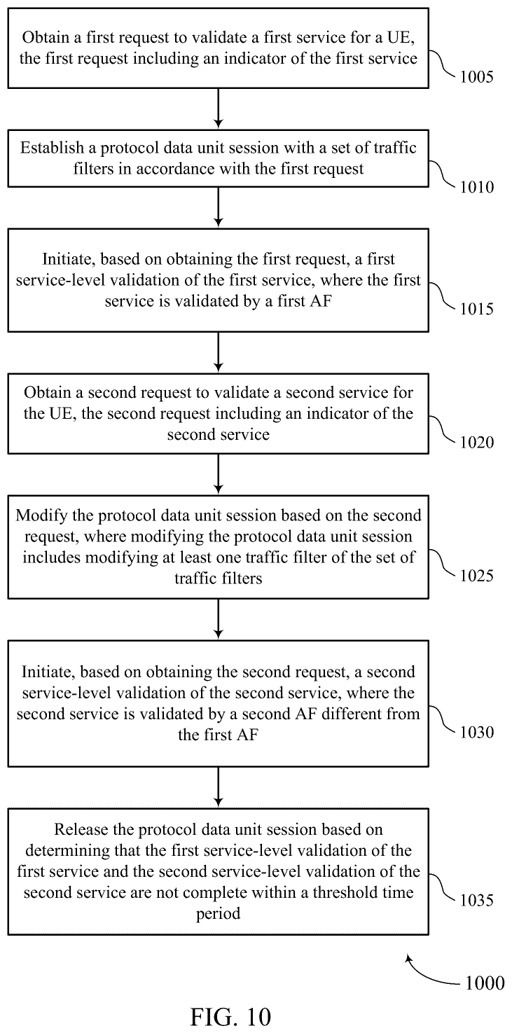

FIG. 10 shows a flowchart illustrating a method 1000 that supports techniques to use service-level AA for multiple applications in accordance with one or more aspects of the present disclosure. The operations of the method 1000 may be implemented by a network entity or its components as described herein. For example, the operations of the method 1000 may be performed by a network entity as described with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1005, the method may include obtaining a first request to validate a first service for a UE, the first request including an indicator of the first service. The operations of 1005 may be performed in accordance with examples as disclosed herein. In some examples, aspects of the operations of 1005 may be performed by a validation request component 625 as described with reference to FIG. 6.

At 1010, the method may include establishing a protocol data unit session with a set of traffic filters in accordance with the first request. The operations of 1010 may be performed in accordance with examples as disclosed herein. In some examples, aspects of the operations of 1010 may be performed by a session establishment component 630 as described with reference to FIG. 6.

At 1015, the method may include initiating, based on obtaining the first request, a first service-level validation of the first service, where the first service is validated by a first AF. The operations of 1015 may be performed in accordance with examples as disclosed herein. In some examples, aspects of the operations of 1015 may be performed by a service-level validation component 640 as described with reference to FIG. 6.

At 1020, the method may include obtaining a second request to validate a second service for the UE, the second request including an indicator of the second service. The operations of 1020 may be performed in accordance with examples as disclosed herein. In some examples, aspects of the operations of 1020 may be performed by a validation request component 625 as described with reference to FIG. 6.

At 1025, the method may include modifying the protocol data unit session based on the second request, where modifying the protocol data unit session includes modifying at least one traffic filter of the set of traffic filters. The operations of 1025 may be performed in accordance with examples as disclosed herein. In some examples, aspects of the operations of 1025 may be performed by a session modification component 635 as described with reference to FIG. 6.

At 1030, the method may include initiating, based on obtaining the second request, a second service-level validation of the second service, where the second service is validated by a second AF different from the first AF. The operations of 1030 may be performed in accordance with examples as disclosed herein. In some examples, aspects of the operations of 1030 may be performed by a service-level validation component 640 as described with reference to FIG. 6.

At 1035, the method may include releasing the protocol data unit session based on determining that the first service-level validation of the first service and the second service-level validation of the second service are not complete within a threshold time period. The operations of 1035 may be performed in accordance with examples as disclosed herein. In some examples, aspects of the operations of 1035 may be performed by a session release component 650 as described with reference to FIG. 6.

The following provides an overview of aspects of the present disclosure:
Aspect 1: A method for wireless communications at a network entity, comprising: obtaining a first request to validate a first service for a UE, the first request comprising an indicator of the first service; establishing a protocol data unit session with a set of traffic filters in accordance with the first request; obtaining a second request to validate a second service for the UE, the second request comprising an indicator of the second service; and modifying the protocol data unit session based at least in part on the second request, wherein modifying the protocol data unit session comprises modifying at least one traffic filter of the set of traffic filters.
Aspect 2: The method of aspect 1, further comprising: initiating, based at least in part on obtaining the first request, a first service-level validation of the first service, wherein the first service is validated by a first application function; and initiating, based at least in part on obtaining the second request, a second service-level validation of the second service, wherein the second service is validated by a second application function different from the first application function.
Aspect 3: The method of aspect 2, wherein the set of traffic filters enable a first flow of traffic associated with the first service based at least in part on the first service-level validation of the first service being successful and the set of traffic filters comprising the modified at least one traffic filter enable a second flow of traffic associated with the second service based at least in part on the second service-level validation of the second service being successful.
Aspect 4: The method of any of aspects 2 through 3, wherein the first application function and the second application function are external to the network entity.
Aspect 5: The method of aspect 4, wherein the network entity communicates with the first application function and the second application function via a network exposure function.
Aspect 6: The method of any of aspects 2 through 5, further comprising: releasing the protocol data unit session based at least in part on determining that the first service-level validation of the first service and the second service-level validation of the second service are not complete within a threshold time period.
Aspect 7: The method of any of aspects 2 through 6, further comprising: obtaining the set of traffic filters to identify a flow of traffic associated with the first service based at least in part on the first service-level validation of the first service being successful.
Aspect 8: The method of any of aspects 1 through 7, further comprising: outputting an indication of a capability to support a service-level validation of services supported by the UE, wherein obtaining the first request and the second request is based at least in part on outputting the indication of the capability.
Aspect 9: The method of any of aspects 1 through 8, further comprising: obtaining an indication of revocation of validation of the first service; and removing a traffic filter from the set of traffic filters in response to obtaining the indication, wherein the traffic filter corresponds to the first service.
Aspect 10: The method of any of aspects 1 through 9, further comprising: determining that the set of traffic filters is exclusive of active traffic filters for the protocol data unit session; and releasing the protocol data unit session in response to determining that the set of traffic filters is exclusive of active traffic filters for the protocol data unit session.
Aspect 11: The method of aspect 10, further comprising: releasing the protocol data unit session comprising releasing the protocol data unit session upon expiration of a timer, wherein the timer is initiated upon determining that set of traffic filters is exclusive of active traffic filters for the protocol data unit session.
Aspect 12: The method of any of aspects 1 through 11, wherein establishing the protocol data unit session is based at least in part on a subscription data, the indicator of the first service, or both, the subscription data indicates that the protocol data unit session is associated with a service-level validation of the UE.
Aspect 13: The method of any of aspects 1 through 12, wherein the set of traffic filters enable flow of traffic not subject to service-level validation, traffic associated with a successful service-level validation, or both.
Aspect 14: The method of any of aspects 1 through 13, wherein the indicator of the first service comprises a service level indicator.
Aspect 15: The method of any of aspects 1 through 14, wherein the network entity comprises a session management function.
Aspect 16: A network entity comprising one or more memories storing processor-executable code, and one or more processors coupled with the one or more memories and individually or collectively operable to execute the code to cause the network entity to perform a method of any of aspects 1 through 15.
Aspect 17: A network entity comprising at least one means for performing a method of any of aspects 1 through 15.
Aspect 18: A non-transitory computer-readable medium storing code the code comprising instructions executable by one or more processors to perform a method of any of aspects 1 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
obtain a first request to validate a first service for a user equipment (UE), the first request comprising an indicator of the first service;
establish a protocol data unit session with a set of traffic filters in accordance with the first request;
obtain a second request to validate a second service for the UE, the second request comprising an indicator of the second service; and
modify the protocol data unit session based at least in part on the second request, wherein modifying the protocol data unit session comprises modifying at least one traffic filter of the set of traffic filters.

2. The network entity of claim 1, wherein the one or more processors are individually or collectively further operable to execute the code to cause the network entity to:
initiate, based at least in part on obtaining the first request, a first service-level validation of the first service, wherein the first service is validated by a first application function; and
initiate, based at least in part on obtaining the second request, a second service-level validation of the second service, wherein the second service is validated by a second application function different from the first application function.

3. The network entity of claim 2, wherein the set of traffic filters enable a first flow of traffic associated with the first service based at least in part on the first service-level validation of the first service being successful and the set of traffic filters comprising the modified at least one traffic filter enable a second flow of traffic associated with the second service based at least in part on the second service-level validation of the second service being successful.

4. The network entity of claim 2, wherein the first application function and the second application function are external to the network entity, and wherein the network entity communicates with the first application function and the second application function via a network exposure function.

5. The network entity of claim 2, wherein the one or more processors are individually or collectively further operable to execute the code to cause the network entity to:
release the protocol data unit session based at least in part on determining that the first service-level validation of the first service and the second service-level validation of the second service are not complete within a threshold time period.

6. The network entity of claim 2, wherein the one or more processors are individually or collectively further operable to execute the code to cause the network entity to:
obtain the set of traffic filters to identify a flow of traffic associated with the first service based at least in part on the first service-level validation of the first service being successful.

7. The network entity of claim 1, wherein the one or more processors are individually or collectively further operable to execute the code to cause the network entity to:
output an indication of a capability to support a service-level validation of services supported by the UE, wherein obtaining the first request and the second request is based at least in part on outputting the indication of the capability.

8. The network entity of claim 1, wherein the one or more processors are individually or collectively further operable to execute the code to cause the network entity to:
obtain an indication of revocation of validation of the first service; and
remove a traffic filter from the set of traffic filters in response to obtaining the indication, wherein the traffic filter corresponds to the first service.

9. The network entity of claim 1, wherein the one or more processors are individually or collectively further operable to execute the code to cause the network entity to:
determine that the set of traffic filters is exclusive of active traffic filters for the protocol data unit session; and
release the protocol data unit session in response to determining that the set of traffic filters is exclusive of active traffic filters for the protocol data unit session.

10. The network entity of claim 9, wherein the one or more processors are individually or collectively further operable to execute the code to cause the network entity to:
release the protocol data unit session upon expiration of a timer, wherein the timer is initiated upon determining that the set of traffic filters is exclusive of active traffic filters for the protocol data unit session.

11. The network entity of claim 1, wherein:
establishing the protocol data unit session is based at least in part on a subscription data, the indicator of the first service, or both; and
the subscription data indicates that the protocol data unit session is associated with a service-level validation of the UE.

12. The network entity of claim 1, wherein the set of traffic filters enable flow of traffic not subject to service-level validation, traffic associated with a successful service-level validation, or both.

13. The network entity of claim 1, wherein the indicator of the first service comprises a service level indicator, and wherein the network entity comprises a session management function.

14. A network entity, comprising:
one or more memories storing processor-executable code; and
one or more processors coupled with the one or more memories and individually or collectively operable to execute the code to cause the network entity to:
obtain an indication to validate a first service for a user equipment (UE);
obtain, from an application function that is selected based at least in part on the indication of the first service, an indication of authentication and authorization of the UE for the first service;
obtain, from the application function, a set of traffic filters associated with the first service;
forward, to a session management function, the indication of the authentication and authorization of the UE for the first service; and
forward, to the session management function, the set of traffic filters obtained from the application function for establishment of a protocol data unit session with the UE.

15. The network entity of claim 14, wherein the one or more processors are individually or collectively further operable to execute the code to cause the network entity to:
obtain an indication to validate a second service for the UE;
obtain, from a second application function that is selected based at least in part on the indication to validate the second service, a second indication of authentication and authorization of the UE for the second service;
obtain, from the application function, a second set of traffic filters associated with the second service; and
forward, to the session management function for modification of at least one traffic filter of the set of traffic filters of the protocol data unit session, the second set of traffic filters and the second indication of authentication and authorization.

16. The network entity of claim 14, wherein the one or more processors are individually or collectively further operable to execute the code to cause the network entity to:
receive a second indication of authentication and authorization of the UE for the first service, wherein the second indication comprises a revocation of validation; and
remove the set of traffic filters associated with the first service from an allowed traffic filter list associated with the UE based at least in part on the revocation of validation.

17. The network entity of claim 16, wherein the one or more processors are individually or collectively further operable to execute the code to cause the network entity to:
release the protocol data unit session associated with the UE based at least in part on the revocation of validation associated with the first service and the first service being a last service associated with the UE.

18. The network entity of claim 14, wherein the network entity comprises a network exposure function.

19. A method for wireless communications at a network entity, comprising:
obtaining a first request to validate a first service for a user equipment (UE), the first request comprising an indicator of the first service;
establishing a protocol data unit session with a set of traffic filters in accordance with the first request;
obtaining a second request to validate a second service for the UE, the second request comprising an indicator of the second service; and
modifying the protocol data unit session based at least in part on the second request, wherein modifying the protocol data unit session comprises modifying at least one traffic filter of the set of traffic filters.

20. The method of claim 19, further comprising:
initiating, based at least in part on obtaining the first request, a first service-level validation of the first service, wherein the first service is validated by a first application function; and
initiating, based at least in part on obtaining the second request, a second service-level validation of the second service, wherein the second service is validated by a second application function different from the first application function.
